(19) United States
(12) Patent Application Publication
(10) Pub. No.: US 2026/0187683 A1
(43) Pub. Date: Jul. 2, 2026

(54) AUTOMATICALLY ESTIMATING A FUTURE VALUE FOR A HOME

(71) Applicant: MFTB Holdco, Inc., Seattle, WA (US)

(72) Inventor: Krishna Rao, Seattle, WA (US)

(21) Appl. No.: 17/870,103

(22) Filed: Jul. 21, 2022

Related U.S. Application Data
(63) Continuation of application No. 14/640,860, filed on Mar. 6, 2015, now abandoned.

(51) Int. Cl. G06Q 30/02

(52) U.S. Cl. CPC G06Q 30/0278

(57) ABSTRACT

A facility for estimating a future value of a home is described. The facility accesses information about homes in the geographic area including values of attributes for the homes and past changes in valuation of the homes, and aggregate changes in valuation across homes in the geographic area over the same period. The facility creates and trains a model to generate an estimated future rate of appreciation for a distinguished home based on values of attributes for the distinguished home and a forecast rate of appreciation for homes in the geographic area. The facility combines the forecast rate of appreciation based on the home's attribute values and a current valuation of the home to generate an estimated future valuation of the home.

### CROSS-REFERENCE TO RELATED APPLICATION

This application is a continuation of U.S. patent application Ser. No. 14/640,860, filed Mar. 6, 2015, entitled “AUTOMATICALLY ESTIMATING A FUTURE VALUE FOR A HOME,” which is incorporated by reference herein in its entirety.

### BACKGROUND

Housing market conditions can materially affect the future value of a home. For example, in a “hot” housing market characterized by limited supply of homes for sale, high demand, and rising prices, a home might be expected to significantly increase in value over, e.g., a year. By contrast, in a depressed market characterized by a large supply, limited demand, and falling prices, a home's future value might be lower than its current value. Various organizations attempt to analyze housing market conditions and project future housing market movement.

### BRIEF DESCRIPTION OF THE DRAWINGS

FIG. 1A is a block diagram showing some of the components typically incorporated in at least some of the computer systems and other devices on which the facility executes.

FIG. 1B is a high-level data flow diagram showing data flow in a typical arrangement of components used to provide the facility.

FIG. 2 is a data flow diagram showing data flow in the facility in some embodiments to apply a relative home appreciation model to generate a home appreciation factor for estimating a future value for a home.

FIG. 3 is a flow diagram showing steps typically performed by the facility in some embodiments to apply a model for estimating a change in home valuation relative to home appreciation in a geographic area to estimate a future valuation for a home.

FIG. 4 is a flow diagram showing steps typically performed by the facility in some embodiments to build a model for estimating a change in home valuation relative to home appreciation in a geographic area.

FIG. 5 is a flow diagram showing steps typically performed by the facility in some embodiments to fit a model of relative home appreciation to stored observations of home attribute values and home appreciation in a geographic area.

FIG. 6 is a table diagram showing sample contents of a table containing home attribute value information as well as home valuations and changes in home valuations over multiple one-year periods.

FIG. 7 is a graph showing valuations of a home and an estimate of a future value of the home, as well as average valuations of homes in a geographic area and forecast home appreciation in the geographic area.

FIG. 8 is a display diagram showing a way in which the facility presents information about an individual home including a future valuation of the home generated by the facility in some embodiments.

### DETAILED DESCRIPTION

### Overview

In many roles, it can be useful to be able to accurately predict the future value of a home. As examples, when they can accurately estimate the future value of a home: lenders can avoid issuing a mortgage loan that is likely to become “underwater” or “upside down,” with an outstanding loan balance greater than the value of the home; homeowners can make renovation decisions based on home equity expectations; sellers and their agents can optimally decide when to list a home for sale; and potential home buyers can make better-informed buy-or-rent decisions to evaluate whether purchasing a house is a good investment.

A variety of conventional approaches exist for estimating a future value of a home. A first is to take a previous period of appreciation of the home and extrapolate future appreciation for the home at the same rate.

Another conventional approach to estimating the future value of a home is to estimate future home values for a region containing the home by projecting a future rate of annual growth in housing prices using information such as national and local economic indicators, housing statistics, and mortgage market data. For example, economists can forecast broad effects from factors such as recorded and/or projected population growth, income growth, unemployment levels, consumer confidence, delinquent loans, mortgage rates, new construction starts, amounts of unsold home inventory, sale and rental price trends, etc. This rate of change of housing prices for the region can be applied to the present value of the home to determine a future price of the home, based on an assumption that the home's appreciation will match the region's.

The inventors have recognized that the conventional approaches to valuing houses have significant disadvantages in the context of a future price estimate for a home. For instance, assuming future appreciation by extrapolating from past appreciation has the disadvantage that market conditions fluctuate, and the home's future appreciation can quickly diverge from its previous path. As a result, the extrapolation approach to estimating the future value of a house tends to be accurate for only a short period and only when the housing market is stable. Accordingly, few if any houses can be accurately valued at a future date using the extrapolation approach.

The approach of estimating regional housing price growth, in turn, has the disadvantage that housing market forecasts that estimate future supply and demand to project whether prices will rise or fall in a geographic region are not direct estimates of the value of a particular home. Such forecasts are aggregate figures for that region and do not accurately predict a given home's future value or appreciation. For example, an individual home can rise or fall in value faster or slower than the market as a whole for the region.

In view of the shortcomings of conventional approaches to estimating a future value of a home discussed above, the inventors have recognized that a new approach to estimating future values of homes that is more frequently accurate and convenient would have significant utility.

A software and/or hardware facility for automatically estimating a future value of a home (“the facility”) is described. Though the following discussion generally employs the words “home,” “house,” and “housing” to refer to the property being valued, those skilled in the art will appreciate that the facility can be straightforwardly applied to properties of other types.

In some embodiments, the facility estimates the future value of an individual home among a plurality of homes in a geographic area. The facility obtains a first valuation of the home at a first time, such as a current valuation of the home generated by an automatic valuation model. The facility also determines an estimate of a rate of change in valuation of the plurality of homes between the first time and a later second time, such as an aggregate housing market one-year forecast for the geographic area. The facility utilizes a model applicable to predict a change in valuation of the individual home relative to the estimated rate of change in the valuation of the plurality of homes, i.e., the housing market forecast. In some embodiments, the model is based on an amount or ratio at which particular homes having particular attributes appreciated while a larger regional market underwent a particular rate of change. In some embodiments, the model is based on home attributes, such as the number of bedrooms and bathrooms and/or what price tier the home is in (e.g., the high, middle, or low end of the market for the geographic area). In some embodiments, the model is based on how much the home appreciated in the past relative to the housing market when the housing market moved in a similar way to the change estimated in the market forecast. The facility applies the first valuation of the home and the estimated change in valuation of the plurality of homes to the model to generate a modifier, then multiplies the market appreciation rate by the modifier, and by the first valuation from the first time to generate a second valuation of the home at a second time. By comparing the second valuation of the home to the first valuation, the facility can determine an estimated future appreciation of the home.

In various embodiments, the facility includes a method to train a model for estimating a change in valuation of a home in a geographic area, and a trained home appreciation model data structure. For example, such a data structure can map from values of attributes for a home in a geographic area, a valuation of the home, and a market appreciation figure for the geographic area to an estimated appreciation figure for the home.

By operating in some or all of the ways described above, the facility enables a user to more accurately project the future value of a particular home, increasing economic certainty and facilitating real estate market transactions.

### Description of Figures

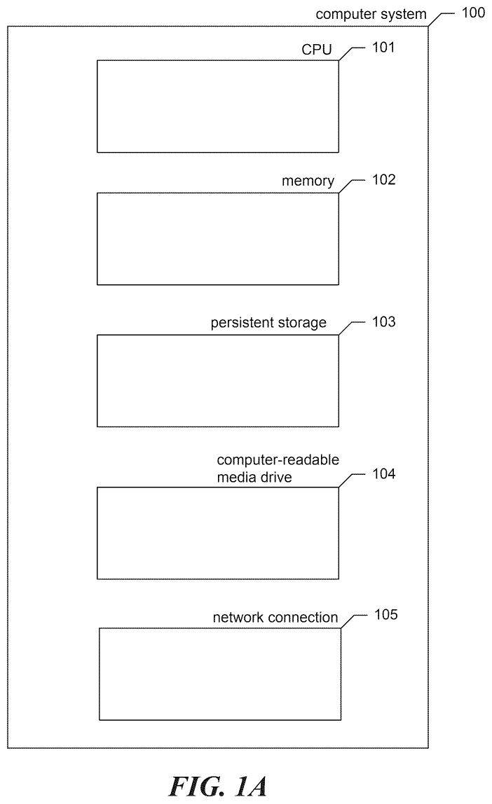

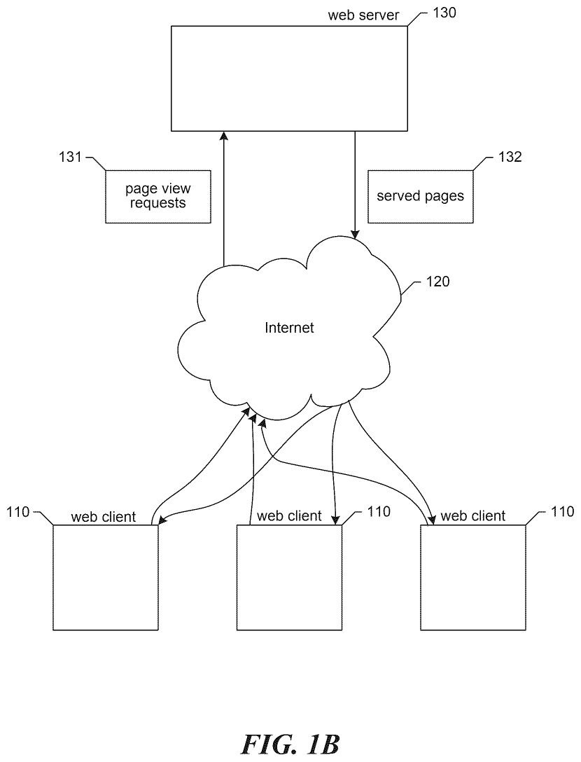

FIG. 1A is a block diagram showing some of the components typically incorporated in at least some of the computer systems and other devices on which the facility executes. These computer systems and devices 100 may include one or more central processing units (“CPUs”) 101 for executing computer programs; a computer memory 102 for storing programs and data—including data structures, database tables, other data tables, etc.—while they are being used; a persistent storage device 103, such as a hard drive, for persistently storing programs and data; a computer-readable media drive 104, such as a USB flash drive, for reading programs and data stored on a computer-readable medium; and a network connection 105 for connecting the computer system to other computer systems, such as via the Internet, to exchange programs and/or data—including data structures. The terms “memory” and “computer-readable storage medium” include any combination of temporary and/or permanent storage, e.g., read-only memory (ROM) and writable memory (e.g., random access memory or RAM), writable non-volatile memory such as flash memory, hard drives, removable media, magnetically or optically readable discs, nanotechnology memory, synthetic biological memory, and so forth, but do not include a propagating signal per se. In various embodiments, the facility can be accessed by any suitable user interface including Web services calls to suitable APIs. While computer systems configured as described above are typically used to support the operation of the facility, one of ordinary skill in the art will appreciate that the facility may be implemented using devices of various types and configurations, and having various components.

FIG. 1B is a high-level data flow diagram showing data flow in a typical arrangement of components used to provide the facility. A number of web client computer systems 110 that are under user control generate and send page view requests 131 to one or more logical web servers 130 via a network such as the Internet 120, such as page requests for pages that include future home valuation estimates generated by the facility. Within the web server, these requests may either all be routed to a single web server computer system, or may be load-balanced among a number of web server computer systems. The web server typically replies to each with a served page 132. Web servers 130 may include computing nodes used to determine home valuation and/or appreciation estimates, or such computing nodes may be remote from the web servers and simply make future valuation and/or appreciation estimates determined by the facility available to the web servers.

While various embodiments are described in terms of the environment described above, those skilled in the art will appreciate that the facility may be implemented in a variety of other environments including a single, monolithic computer system, as well as various other combinations of computer systems or similar devices connected in various ways including cloud computing resources. In various embodiments, a variety of computing systems or other different client devices may be used in place of the web client computer systems, such as mobile phones, personal digital assistants, televisions and associated video sources, cameras, tablet computer systems, laptop computer systems, desktop computer systems, wearable computing devices, etc.

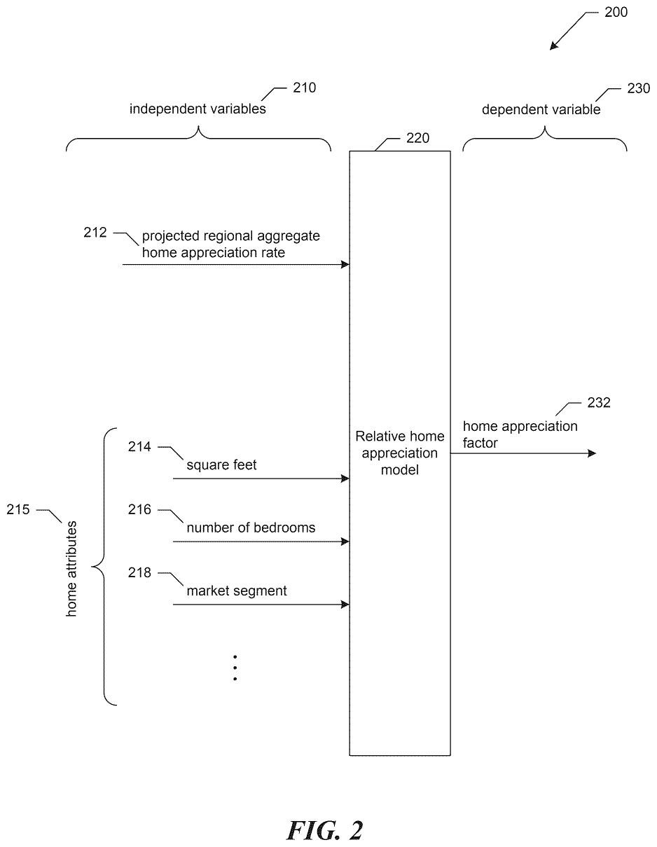

FIG. 2 is a data flow diagram showing data flow in the facility in some embodiments to apply a relative home appreciation model to generate a home appreciation factor for estimating a future value for a distinguished home. In various embodiments, a server computing system (e.g., the web servers 130 of FIG. 1B) and/or one or more other processing devices operably connectable to the server computing system, such as an electronic device owned by a user (e.g., a web client computer system 110) can implement the relative home appreciation model and the data flows depicted in FIG. 2. Independent variables 210 are provided to a relative home appreciation model 220. The independent variables 210 include a projected regional aggregate home appreciation rate 212. For example, such a rate can include a forecast of how housing prices overall or in a particular category of homes (e.g., condos or single-family homes) will change in a given region over some time frame. The geographic region to which the projected rate applies may be the nation, a state, a metropolitan area, a county, etc., depending on the source of data upon which the forecast is based. The range of the forecast may be, for example, a month, a quarter, a year, or a multi-year period.

In the illustrated embodiment, the independent variables 210 also include home attributes 215. For example, the home attributes 215 include the number of square feet 214 of the distinguished home and the number of bedrooms 216 in the home. The home attributes 215 can also include, for example, a market segment 218 indicating whether the home is in a high-end, middle, or low-end segment of homes in the geographic region. In various embodiments, the independent variables 210 that are inputs to the relative home appreciation model 220 can include values of additional, fewer, and/or different home attributes. The independent variables 210 can include values on a continuous range, such as the square footage 214, and/or categorized variables such as the market segment 218. In some embodiments, the independent variables 210 include additional types of data, such as information about a past relative rate of appreciation of the distinguished home.

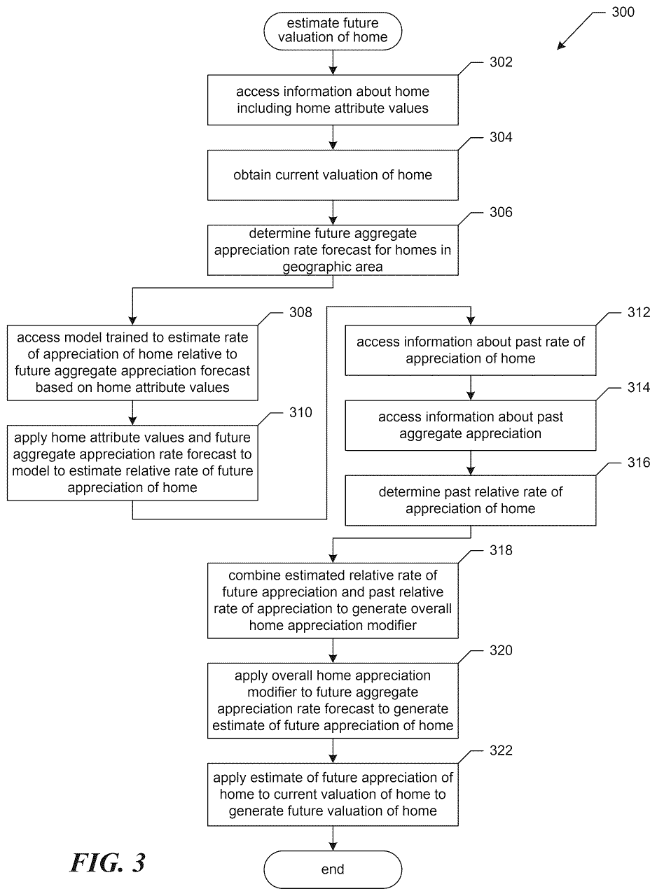

The relative home appreciation model 220 uses the independent variables 210 to generate a dependent variable 230: a home appreciation factor 232. The home appreciation factor 232 indicates an expected relative level of appreciation for the distinguished home in comparison to the projected regional aggregate home appreciation rate 212. For example, if the home appreciation factor 232 is 1.05, then the appreciation rate for the distinguished home is expected to be five percent greater than the regional forecast, i.e., 105% of the projected regional aggregate home appreciation rate 212. As another example, if the home appreciation factor 232 is 0.98, then the appreciation rate for the distinguished home is expected to be two percent less than the regional forecast, i.e., 98% of the projected regional aggregate home appreciation rate 212. As yet another example, if the home appreciation factor 232 is −0.2, then the appreciation rate for the distinguished home is expected to be twenty percent in the opposite direction of the projected regional aggregate home appreciation rate 212, such as a forecast two-tenths of a percent rise in the value of the home in comparison to a one percent fall in projected regional aggregate home values. In some embodiments, the facility combines the output of the relative home appreciation model, i.e., the home appreciation factor 232, with information about a past relative rate of appreciation of the distinguished home to generate an overall home appreciation modifier for the distinguished home, as further described below with reference to FIG. 3.

FIG. 3 is a flow diagram showing steps typically performed by the facility in some embodiments to apply a model for estimating a change in home valuation relative to home appreciation in a geographic area to estimate a future valuation for a home. In various embodiments, the facility performs these steps for one or more geographic areas of one or more different granularities, including ZIP code, neighborhood, city, county, state, country, etc. In some embodiments these steps are performed periodically for each geographic area, such as monthly. In step 302, the facility accesses information about the home, including values of attributes of the home, such as the home attributes 215 of FIG. 2. Such home attribute values can include, for example, the square footage of the home, the number of bedrooms and/or bathrooms in the home, the home's location (e.g., ZIP Code, neighborhood, GPS coordinates, and/or street address), a location quality indicator (e.g., a walkability score, street traffic volume data, distance to amenities, crime figures, etc.), its year of construction, a construction quality indicator, a tax assessment figure, market segment, etc. In some embodiments, the facility ignores or imputes missing values. In step 304, the facility obtains a current valuation of the home. In some embodiments, the valuation is an automatically generated valuation of the home. The valuation can also include, for example, a sale price, a listing price, or a synthetic sale price. In step 306, the facility determines a future aggregate appreciation rate forecast for homes in the geographic area, such as the projected regional aggregate home appreciation rate 212 of FIG. 2. In some embodiments, the facility expresses the future aggregate appreciation rate forecast for the geographic area in relation to an index or average valuation of some or all homes in the geographic area. For example, in some embodiments, the facility subtracts the current home value index from a projected future home value index amount and divides the difference by the current home value index to determine the future aggregate appreciation rate forecast for the geographic area.

In step 308, the facility accesses a model trained to estimate, based on the home's attribute values, a rate of appreciation of the home relative to the future aggregate appreciation forecast for the geographic area. For example, the facility can access the relative home appreciation model 220 of FIG. 2. In step 310, the facility applies the home's attribute values and the future aggregate appreciation rate forecast to the model, and obtains from the model an estimate of a relative rate of future appreciation of the home, such as the home appreciation factor 232 of FIG. 2.

In step 312, the facility accesses information about a past rate of appreciation of the home. For example, the facility can obtain a record of a past valuation of the home, such as an automatic valuation of the home performed one month or one year previously. By comparing the past valuation to the current valuation, the facility can determine a past rate of appreciation of the home over the given period of time. For example, in some embodiments the facility subtracts the past valuation of the home from the current valuation of the home, and divides the difference by the current valuation of the home to determine a past rate of appreciation of the home. In step 314, the facility accesses information about a past aggregate appreciation rate for the geographic area. In some embodiments, the facility periodically determines an average (e.g., a median) or generates an index of some or all home values in the geographic area. By comparing such a home value index at different times, such as comparing the home value index as of the past valuation of the home to the current home value index, the facility can determine a past aggregate appreciation rate for the geographic area over the same period of time. For example, in some embodiments the facility subtracts the past home value index from the current home value index, and divides the difference by the current home value index to determine a past aggregate appreciation rate for the geographic area.

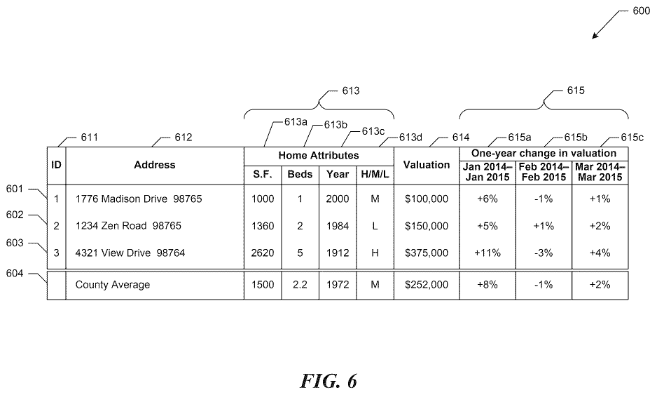

In step 316, the facility determines a past relative rate of appreciation of the home. An example of data regarding home attributes and individual and aggregate home appreciation is the table shown in FIG. 6. The facility can compare the past rate of appreciation of the home to the past aggregate appreciation rate for the geographic area to determine how much the home appreciated relative to homes in the geographic area generally. For example, the facility can determine the past relative rate of appreciation for the home by dividing the past rate of appreciation of the home from step 312 by the past aggregate rate of appreciation for homes in the geographic area from step 314.

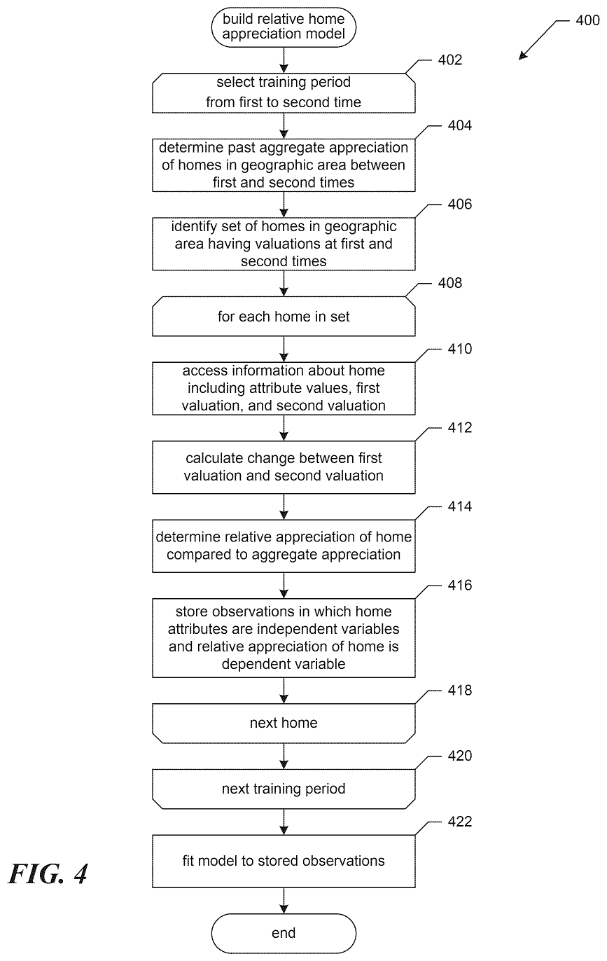

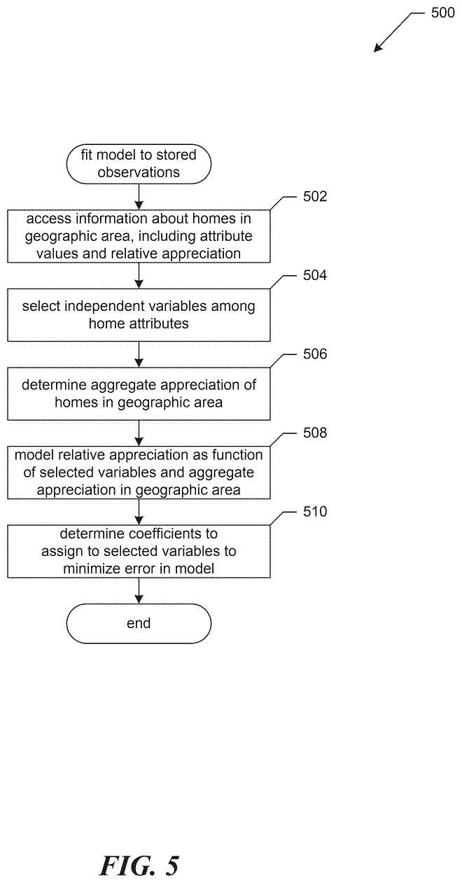

In step 318, the facility combines the estimated relative rate of future appreciation from step 310 and the past relative rate of appreciation from step 316 to generate an overall home appreciation modifier for the home. For example, the facility can express the overall home appreciation modifier for the home as a polynomial or vector function such as α+β * estimated relative rate of future appreciation (e.g., the home appreciation factor 232 generated by the model)+γ * past relative rate of appreciation, where α, β, and γ are coefficients to give the factors appropriate weight. The equation combining the rates of appreciation to generate an overall home appreciation modifier for the home can include various factors and coefficients without necessarily being linear. The α, β, and γ coefficients in the above example can be determined experimentally (e.g., by a linear regression analysis) to minimize error and maximize the predictive accuracy of the overall home appreciation modifier for the home, as described below with reference to step of 422 of FIG. 4 and to FIG. 5.

In step 320, the facility applies the overall home appreciation modifier for the home to the future aggregate appreciation rate forecast to generate an estimate of future appreciation of the home. In some embodiments, the facility multiplies the overall home appreciation modifier from step 318 and the future aggregate appreciation rate forecast for the geographic area from step 306 to produce an projected appreciation rate for the home. In some embodiments, the facility combines the overall home appreciation modifier for the home and the future aggregate appreciation rate forecast non-multiplicatively, such as additively (e.g., adding a positive or negative appreciation modifier for the home to an aggregate forecast appreciation amount). In step 322, the facility applies the estimate of future appreciation of the home to the current valuation of the home obtained in step 304 to generate a future valuation of the home. For example, in some embodiments, the facility multiplies the estimate of future appreciation of the home by the current valuation of the home and then adds the current valuation of the home to produce a future valuation of the home.

Those skilled in the art will appreciate that the steps shown in FIG. 3 and in each of the flow diagrams discussed below may be altered in a variety of ways. For example, the order of the steps may be rearranged; some steps may be performed in parallel; shown steps may be omitted, or other steps may be included; etc.

FIG. 4 is a flow diagram showing steps typically performed by the facility in some embodiments to build a model for estimating a change in home valuation relative to home appreciation in a geographic area. The facility selects at least one training period from a first time (in the past) to a second time (in the past or the current time), and carries out steps 402-420 for each selected training period. For example, the facility can select a one-year training period from two years ago to one year ago, and then select a one-year training period from twenty-three months ago to eleven months ago. In step 404, the facility determines a past aggregate appreciation of homes in geographic area between the first time and the second time. For example, the facility can determine a past aggregate appreciation rate for the geographic area in the manner described in step 314 of FIG. 3. In step 406, the facility identifies a set of homes in a geographic area each having valuations at the first time and at the second time. For example, the facility can access records of automatic valuations that were generated for a particular home at the first and second times (i.e., a valuation history for the particular home).

The facility carries out steps 408-418 for each home in the set of homes having valuations at the first time and at the second time. In step 410, the facility accesses information about the home including values of the home's attributes, the first valuation as of the first time, and the second valuation as of the second time. In step 412, the facility calculates the change between the first valuation and second valuation. For example, the facility can determine the change in terms of dollar value, percentage appreciation, etc. In step 414, the facility determines the relative appreciation of the home as compared to the aggregate appreciation of homes in the geographic area from step 404. For example, the facility can express the relative appreciation as a ratio (e.g., a ratio between appreciation percentages or changes in dollar value), a mathematical difference (e.g., between appreciation percentages, dollar values, or dollar value changes), etc. In step 416, the facility stores the observations for the home, in which the home's attribute values are independent variables and the relative appreciation of the home is a dependent variable. In some embodiments, the facility includes the aggregate appreciation for the geographic area as an independent variable. (For example, the relative appreciation of a home may be dependent on the amount and/or direction of market movement as well as the home's attribute values.) In step 418 the facility proceeds to the next home. In step 420, after iterating through each home in the set of homes, the facility proceeds to the next training period. In step 422, the facility fits a model to the stored observations. In some embodiments, the facility utilizes a theoretical regression approach (e.g., a linear regression analysis) to train the model on the historical data. Fitting the model to the stored observations is further described below with reference to FIG. 5.

FIG. 5 is a flow diagram showing steps typically performed by the facility in some embodiments to fit a model of relative home appreciation to stored observations of home attribute values and home appreciation in a geographic area. In step 502, the facility accesses information about homes in the geographic area including the values of attributes of the homes and their past rates of appreciation (e.g., rates of appreciation relative to an index of the housing market in the geographic area) over one or more periods of time. An example of data regarding home attributes and individual and aggregate home appreciation is the table shown in FIG. 6. In step 504, the facility selects independent variables among the home attributes. For example, values of a particular home attribute may be strongly correlated with amounts of relative home appreciation, giving it strong predictive power; whereas values of another home attribute may be less strongly correlated or substantially collinear with another independent variable, giving it less predictive power. Accordingly, in step 504, the facility seeks to select independent variables that produce the best fit to the observed data while avoiding over-fitting. In step 506, the facility determines one or more aggregate amounts and/or rates of appreciation of homes in the geographic area for each of the one or more periods of time, such as each of the past aggregate home appreciation rates from step 404 of FIG. 4. In step 508, the facility models the relative appreciation of the homes as a function of the selected independent variables and the aggregate amount or rate of appreciation in the geographic area over each period of time. For example, the facility can generate a model that produces, for a given home in the geographic area, a home appreciation modifier such as a multiplier that predicts how much the valuation of the home will change for a given change in the aggregate valuation of homes in the geographic area. In some embodiments, the facility produces a model that expresses an estimated appreciation rate for a given home as a function of property characteristics including past relative rates of appreciation, such as the function described above with reference to step 318 of FIG. 3. In step 510, the facility determines coefficients to assign to the selected independent variables to minimize error in the model. In various embodiments, the facility performs the modeling of steps 508 and 510 by various statistical approaches such as linear regression. In some embodiments, the facility determines coefficients based on data from a training set of home attribute values and past relative home appreciation, and verifies the fit of the model on a test set of different homes' home attribute values and past relative home appreciation.

FIG. 6 is a table diagram showing sample contents of a table containing home attribute value information as well as home valuations and changes in home valuations over multiple one-year periods. The home attributes and appreciation table 600 is made up of rows 601-603, each representing a home in a particular geographic area, such as a county, and row 604, representing a countywide average or index of home attributes and aggregate changes in home valuations. Each row is divided into the following columns: an identifier column 611 containing an identifier for the home; an address column 612 containing the address of the home; home attributes column 613 containing values of attributes of the home including sub-columns 613a-613d for, respectively, square footage, number of bedrooms, year of construction, and a market segment indicator; a valuation column 614 containing a valuation of the home (e.g., an automatic valuation); and a one-year change in valuation column 615 including sub-columns 615a-615c containing the percentage appreciation rate for the home (and the county) over a series of one-year periods.

For example, row 601 indicates that home number 1 is located at 1776 Madison Drive 98765, has 1000 square feet and one bedroom, was built in 2000, is in the middle of the market (versus, e.g., low-end or high-end homes), has an estimated valuation of $100,000, and has in succeeding monthly year-over-year changes in valuation, appreciated six percent, depreciated one percent, and appreciated one percent. Row 604 indicates that in the county overall, the average home had 1500 square feet and 2.2 bedrooms, was built in 1972 and is in the middle of the market with a valuation of $252,000; and that in running one-year periods determined on a monthly basis, the county averaged positive eight percent appreciation, negative one percent depreciation, and positive two percent appreciation.

Though the contents of home attributes and appreciation table 600 are included to present a comprehensible example, those skilled in the art will appreciate that the facility can use a home attributes and appreciation table 600 having columns corresponding to different and/or a larger number of attributes, as well as a larger number of rows. The table may include, for example, data about additional or different home attributes, such as lot size and dimensions, structure type, construction materials, number of bathrooms, heat source, cooling technology, roof type and age, fireplaces, parking, swimming pool, zoning or occupancy type, view type and quality, number of rooms, number of stories, school district, longitude and latitude, neighborhood or subdivision, tax assessment, attic and other storage, etc. For a variety of reasons, certain values may be omitted from the home improvements and home sales table 600. In some embodiments, the facility imputes missing values using the median value in the same column for continuous variables, or the mode (i.e., most frequent) value for categorical values. In other embodiments, the imputation is a multivariate prediction based on the other non-missing attributes. In some embodiments, the facility filters the information to exclude data such as outlier values and unreliable information, e.g., by ignoring a questionable value or excluding a home associated with undependable data. Though FIG. 6 shows a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be indexed in ways not shown; may be compressed and/or encrypted; etc.

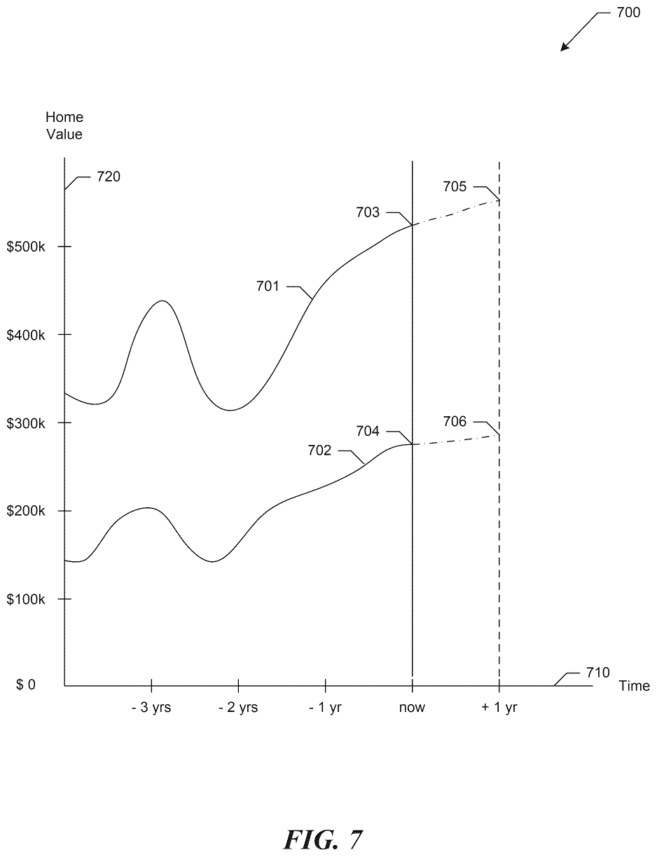

FIG. 7 is a graph showing valuations of a home and an estimate of a future value of the home, as well as average valuations of homes in a geographic area and forecast home appreciation in the geographic area. The graph 700 includes a horizontal axis 710 showing time in years. The timeline on the horizontal axis 710 includes indicators for both a past number of years and one year into the future. A solid vertical line on the graph indicates the present time, and a dashed vertical line indicates the time one year from the present time. The graph 700 also includes a vertical axis 720 showing home value in dollars. Two curves, 701 and 702, plot valuations (and changes in valuation) over time. Curve 701 shows past valuations of a particular home, culminating in a current valuation 703 of approximately $525,000. Curve 702 shows an aggregate index or average of valuations of multiple homes in a geographic area over the same period, up to a current index value 704 of approximately $275,000. Based on a forecast rate or amount of appreciation for homes in the geographic area, the graph 700 plots a future aggregate index value 706 of approximately $ 285,000, or roughly 3 ½% appreciation over one year into the future. The facility connects the current index value 704 to the estimated future index value 706 via a broken line on the graph 700. The facility can generate the broken line by interpolating valuation amounts and/or generating a curve that smoothly connects the current valuation and the future valuation. The facility can also generate a future valuation 705 for the particular home of curve 701 in the manner described above with reference to FIG. 3. In a similar manner to generating the broken line between valuation points 704 and 706, the facility can graph a path along curve 701 between the home's current valuation 703 and its estimated future valuation 705. The illustrated curves 701 and 702 show that the particular home tends to have a greater amount of volatility than the market overall; that is, for a given change in the index of valuations for the geographic area, a home appreciation multiplier for the particular home would be positive and greater than one.

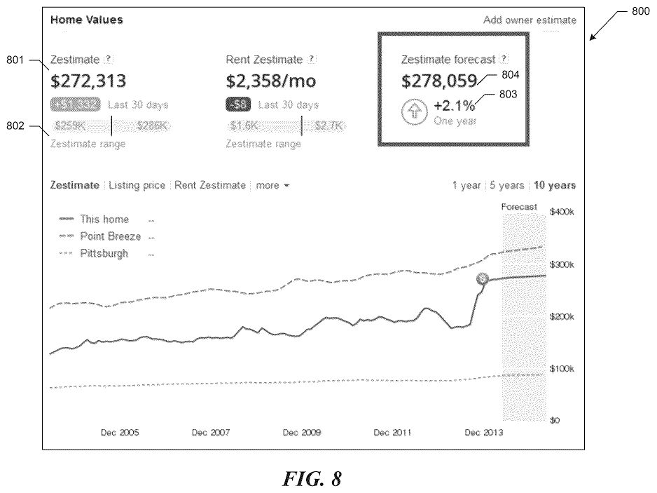

FIG. 8 is a display diagram showing a way in which the facility presents information about an individual home including a future valuation of the home generated by the facility in some embodiments. The display 800 includes a current valuation 801 and a range or confidence interval of valuation estimates 802 for the home, enabling prospective buyers and listing agents to gauge their interest in the home, or permitting the home's owner to gauge his or her interest in listing the home for sale. It also displays a projected one-year rate of appreciation 803 for the home, and based on that projected rate of appreciation 803, displays a future valuation estimate 804. In various embodiments, other future valuation rate data is shown in a variety of ways. For example, in a display of information about a home similar to the display 800, the facility can display a range of estimates of a future home valuation and/or rate of appreciation. The facility can also present a rate of appreciation relative to expected aggregate market appreciation, such as whether the home is expected to appreciate (or depreciate) more or less than other homes in its neighborhood, county, state, etc., in percentage terms and/or dollar value.

### Conclusion

It will be appreciated by those skilled in the art that the above-described facility may be straightforwardly adapted or extended in various ways. For example, the facility may use a wide variety of modeling techniques, house attributes, and/or data sources. The facility may display or otherwise present its future appreciation and/or valuation estimates in a variety of ways. While the foregoing description makes reference to particular embodiments, the scope of the invention is defined solely by the claims that follow and the elements recited therein.

1. (canceled)

2. A computer-readable storage medium having contents configured to cause a computing system to perform a method for estimating a future valuation of a first home among a plurality of homes in a geographic area, the method comprising:
determining a first valuation of the first home at a first time;
generating a model comprising a plurality of independent variables with each independent variable being associated with a corresponding coefficient of a plurality of coefficients, wherein the plurality of independent variables includes at least one or more home attributes;
determining, using a first training data set, a value for each of the plurality of coefficients to minimize an error in the model;
verifying, using a second training data set different from the first training data set, a fit of the model to generate a verified model, the verifying including:
applying the model to the second training data set to generate a predicted relative appreciation values;
comparing the predicted relative appreciation values to observed relative appreciation values of the homes in the second training data set; and
upon determining that the predicted relative appreciation values from the model are within a threshold amount to observed relative appreciation values, verifying the fit of the model on a third set of home data different from the first training data set and the second training data set;
determining, using the verified model, a relative rate of appreciation with respect to a forecast aggregate appreciation rate for the plurality of homes in the geographic area between the first time and a second time that is later than the first time;
generating, based on the plurality of independent variables, a home-specific appreciation modifier from the relative rate of appreciation;
generating a second valuation of the first home at the second time by applying the home-specific appreciation modifier to the forecast aggregate appreciation rate and multiplying a resulting adjusted appreciation rate, and the first valuation of the first home; and
determining an estimated future appreciation of the home by comparing the second valuation to the first valuation.

3. The computer-readable storage medium of claim 2, wherein the first training data set comprises a set of home attribute values and past relative home appreciation for a first set of homes, and wherein the second training data set comprises the set of home attribute values and past relative home appreciation for a second set of home that is different from the first set of homes.

4. The computer-readable storage medium of claim 2, wherein the method, as part of generating the modifier, comprises:
generating, based on the plurality of independent variables, a dependent variable indicative of an expected relative level of appreciation for the home in comparison to a projected regional aggregate home appreciation rate; and
combining the dependent variable with information about a past relative rate of appreciation of the home to generate the modifier.

5. The computer-readable storage medium of claim 2, wherein the modifier is expressed as a polynomial or a vector function.

6. The computer-readable storage medium of claim 2, wherein each of the first time and the second time does not exceed a current time, and wherein the method further comprises:
interpolating valuation amounts between the first time and the second time by generating a curve smoothly connecting the first valuation of the home and the second valuation of home.

7. The computer-readable storage medium of claim 6, wherein the method further comprises:
generating, using the curve, a future valuation of the home at a future time that exceeds the current time.

8. The computer-readable storage medium of claim 7, wherein the future valuation of the home is associated with a range or a confidence interval.

9. The computer-readable storage medium of claim 2, wherein the one or more home attributes include at least one of a square footage of the home, a number of bedrooms or bathrooms in the home, a location of the home, a location quality indicator, a year of construction of the home, a construction quality indicator, or a tax assessment figure.

10. A method for estimating a future valuation of a first home among a plurality of homes in a geographic area, comprising:
determining a first valuation of the first home at a first time;
generating a model comprising a plurality of independent variables with each independent variable being associated with a corresponding coefficient of a plurality of coefficients, wherein the plurality of independent variables includes at least one or more home attributes;
determining, using a first training data set, a value for each of the plurality of coefficients to minimize an error in the model;
verifying, using a second training data set different from the first training data set, a fit of the model to generate a verified model, the verifying including:
applying the model to the second training data set to generate a predicted relative appreciation values;
comparing the predicted relative appreciation values to observed relative appreciation values of the homes in the second training data set; and
upon determining that the predicted relative appreciation values from the model are within a threshold amount to observed relative appreciation values, verifying the fit of the model on a third set of home data different from the first training data set and the second training data set;
determining, using the verified model, a relative rate of appreciation with respect to a forecast aggregate appreciation rate for the plurality of homes in the geographic area between the first time and a second time that is later than the first time;
generating, based on the plurality of independent variables, a home-specific appreciation modifier from the relative rate of appreciation;
generating a second valuation of the first home at the second time by applying the home-specific appreciation modifier to the forecast aggregate appreciation rate and multiplying a resulting adjusted appreciation rate, and the first valuation of the first home; and
determining an estimated future appreciation of the home by comparing the second valuation to the first valuation.

11. The method of claim 10, wherein the first training data set comprises a set of home attribute values and past relative home appreciation for a first set of homes, and wherein the second training data set comprises the set of home attribute values and past relative home appreciation for a second set of home that is different from the first set of homes.

12. The method of claim 10, wherein generating the modifier comprises:
generating, based on the plurality of independent variables, a dependent variable indicative of an expected relative level of appreciation for the home in comparison to a projected regional aggregate home appreciation rate; and
combining the dependent variable with information about a past relative rate of appreciation of the home to generate the modifier.

13. The method of claim 10, wherein the modifier is expressed as a polynomial or a vector function.

14. The method of claim 10, wherein each of the first time and the second time does not exceed a current time, and wherein the method further comprises:
interpolating valuation amounts between the first time and the second time by generating a curve smoothly connecting the first valuation of the home and the second valuation of home.

15. The method of claim 14, wherein the method further comprises: generating, using the curve, a future valuation of the home at a future time that exceeds the current time.

16. The method of claim 15, wherein the future valuation of the home is associated with a range or a confidence interval.

17. The method of claim 10, wherein the one or more home attributes include at least one of a square footage of the home, a number of bedrooms or bathrooms in the home, a location of the home, a location quality indicator, a year of construction of the home, a construction quality indicator, or a tax assessment figure.

18. An apparatus for estimating a future valuation of a first home among a plurality of homes in a geographic area, comprising:
a processor; and
a memory coupled to the processor, the memory comprising instructions, the instructions when executed cause the processor to:
determine a first valuation of the first home at a first time;
generate a model comprising a plurality of independent variables with each independent variable being associated with a corresponding coefficient of a plurality of coefficients, wherein the plurality of independent variables includes at least one or more home attributes;
determine, using a first training data set, a value for each of the plurality of coefficients to minimize an error in the model;
verify, using a second training data set different from the first training data set, a fit of the model to generate a verified model, including to:
apply the model to the second training data set to generate a predicted relative appreciation values;
compare the predicted relative appreciation values to observed relative appreciation values of the homes in the second training data set; and
upon determining that the predicted relative appreciation values from the model are within a threshold amount to observed relative appreciation values, verify the fit of the model on a third set of home data different from the first training data set and the second training data set;
determine, using the verified model, a relative rate of appreciation with respect to a forecast aggregate appreciation rate for the plurality of homes in the geographic area between the first time and a second time that is later than the first time;
generate, based on the plurality of independent variables, a home-specific appreciation modifier from the relative rate of appreciation;
generate a second valuation of the first home at the second time by applying the home-specific appreciation modifier to the forecast aggregate appreciation rate and multiplying a resulting adjusted appreciation rate, and the first valuation of the first home; and
determine an estimated future appreciation of the home by comparing the second valuation to the first valuation.

19. The apparatus of claim 18, wherein the first training data set comprises a set of home attribute values and past relative home appreciation for a first set of homes, and wherein the second training data set comprises the set of home attribute values and past relative home appreciation for a second set of home that is different from the first set of homes.

20. The apparatus of claim 18, wherein the modifier is expressed as a polynomial or a vector function.

21. The apparatus of claim 18, wherein the one or more home attributes include at least one of a square footage of the home, a number of bedrooms or bathrooms in the home, a location of the home, a location quality indicator, a year of construction of the home, a construction quality indicator, or a tax assessment figure.
